(19) United States
(12) Patent Application Publication
(10) Pub. No.: US 2014/0270573 A1
(43) Pub. Date: Sep. 18, 2014

(54) METHOD FOR BACKGROUND REMOVAL IN BINARY DOCUMENT IMAGE BY ESTIMATING LINEARITY OF IMAGE COMPONENTS

(71) Applicant: Shugo Ishizaka, Tokyo (JP)

(72) Inventor: Shugo Ishizaka, Tokyo (JP)

(73) Assignee: KONICA MINOLTA LABORATORY U.S.A., INC., San Mateo, CA (US)

(21) Appl. No.: 13/795,456

(22) Filed: Mar. 12, 2013

(51) Int. Cl. G06K 9/32

(52) U.S. Cl. CPC G06K 9/32
USPC 382/296

(57) ABSTRACT

A method of processing a binary document image to remove non-text elements including long straight lines. The method uses a least squares method to fit the pixels of an image component to a line, and then use the coefficient of determination as a measure of linearity of the image component. For each image component, the line fitting and the coefficient of determination are performed twice, once on the original pixel coordinates and once after the image component is rotated 45 degrees. The higher one of the two calculated coefficients of determination is used to determine whether the image component is a straight line. If it is, and if the line is longer than a certain length, it is removed from the document image as a non-text element.

### BACKGROUND OF THE INVENTION

1. Field of the Invention

This invention relates to document image processing, and in particular, it relates to a method of analyzing a scanned document image to eliminate non-text elements in the image such as long straight lines.

2. Description of Related Art

Printed document are often scanned into digital images for digital processing, such as optical character recognition (OCR), document authentication (i.e. to determine whether the document image is identical in content to an original image of the document before the original image was printed, circulated and scanned back), etc. It is often desirable to remove non-text elements, such as graphics and pictures, in the document image before such processing. Various algorithms have been used to remove non-text elements.

One type of non-text elements often present in document images is lines. For example, horizontal and vertical straight lines are often present as a part of tables and charts, underline, etc. Sometimes it is desirable to remove such lines before OCR and other processing. In another example, some document images contain gray or colored objects as background patterns overlapping with text; when such a color or grayscale document image (scanned from a hard copy) is binarized, some binatization algorithms perform edge detection and generate edge lines that correspond to outlines or other edges of the gray or colored objects. It is often desirable to remove such lines before OCR and other processing.

### SUMMARY

Lines in binarized document images may be straight lines or curves; most curves may be locally approximated by straight lines. The present invention is directed to a method of processing a document image to identify and remove straight lines from a binary document image.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method of processing a binary document image, which includes: (a) obtaining a plurality of image components from the document image, each image components comprising a set of black pixels, each black pixel having x and y coordinates; for each image component, (b) calculating a first straight line fit and a first coefficient of determination using the x and y coordinates of the set of black pixels; (c) rotating the image component by a predetermined angle to generate rotated x and y coordinates for each of the set of black pixels; (d) calculating a second straight line fit and a second coefficient of determination using the rotated x and y coordinates of the set of black pixels; (e) if a higher one of the first and second coefficients of determination calculated in steps (b) and (d) is higher than a first threshold value, estimating a length of the image component; and (f) if the length estimated in step (e) is longer than a second threshold value, removing the image component from the document image.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIGS. 1(a) and 1(b) schematically illustrate an example of an image component forming a near-vertical line.

FIG. 2 schematically illustrates a method for removing straight lines from document image according to an embodiment of the present invention

FIG. 3 schematically illustrates a data processing apparatus in which embodiments of the present invention may be implemented.

### DETAILED DESCRIPTION OF PREFERRED EMBODIMENTS

The method described below can be implemented in a data processing system or apparatus, such as a computer 120 shown in FIG. 3, which includes a processor 121, an internal memory (e.g. RAM) 123 and a storage device (e.g. hard disk drive) 122. The data processing system may be a standalone computer connected to a scanner or copier or multi-function device 130 or it may be a part of such a scanner or copier or multi-function device. The data processing system carries out the method by the processor 121 executing computer programs which is stored in the storage device 122 and read out to the RAM 123. In one aspect, the invention is embodied in a data processing system or apparatus. In another aspect, the invention is computer program product embodied in computer usable non-transitory medium (e.g. storage 122) having a computer readable program code embedded therein for controlling a data processing apparatus. In another aspect, the invention is a method carried out by a data processing system.

Embodiments of the present invention use a measure of linearity as a way of determining whether an image component is non-text content. The document image being processes is a binary image where each pixel is black or white. An image component as used in this disclosure refers to an image object formed by multiple connected black pixels. A goal of the image processing method according to embodiments of the present invention is to determine whether the image component is a straight line. Empirically, straight lines longer than a certain length (e.g. typical size of a text character) are more likely to be non-text content. Thus, an image component may be deemed to be non-text object if is a straight line longer than a threshold length.

Embodiments of the present invention use a linear least squares method to fit the pixels of an image component to a line, and then use the coefficient of determination as a measure of linearity of the image component. Let (xᵢ, yᵢ) be the x and y coordinates of the multiple black pixels forming the image component. A straight line fit, y=f(x), is obtained as follows (Eqs. (1)):

$$y = f ( x ) = a + bx$$

$$a = \frac{\overline{y} {\sum }_{i}^{ } {x}_{i}^{2} - \overline{x} {\sum }_{i}^{ } {x}_{i} {y}_{i}}{{\sum }_{i}^{ } {x}_{i}^{2} - n {\overline{x}}^{2}}$$

$$b = \frac{{\sum }_{i}^{ } {x}_{i} {y}_{i} - n \overline{x} \overline{y}}{{\sum }_{i}^{ } {x}_{i}^{2} - n {\overline{x}}^{2}}$$

where x̅ and y̅ are the average of xᵢ and yᵢ and n is the total number of black pixels forming the image component.

The coefficient of determination is defined as follows (Eq. 2):

$${R}^{2} = 1 - \frac{{\sum }_{i}^{ } {( {y}_{i} - f ( {x}_{i} ) )}^{2}}{{\sum }_{i}^{ } {( {y}_{i} - \overline{y} )}^{2}}$$

where f(xᵢ) is the linear function calculated from Eq. (1). The value of the coefficient of determination R² ranges between 0 and 1. A value of R²=1 indicates that the line model fits the data well; a value of R²=0 indicates that there is no “linear” relationship between x and y. The coefficient of determination is a suitable measure of linearity of an image segment, and is relatively easy to calculate.

However, when the set of points form a line y=f(x) that is close to vertical or horizontal, the calculation of the coefficient of determination value R² tends to be inaccurate. To solve this problem, the processing method according to embodiments of the present invention calculates the coefficient of determination twice: the first time it is calculated using the original data of the image component; the second time it is calculated after applying a 45-degree rotation to the image component. The two calculated coefficient of determination values are compared, and the higher value is used for further steps.

FIGS. 1(a) and 1(b) schematically illustrate an example of an image component forming a near-vertical line. FIG. 1(a) schematically shows the image component, formed by 7 black pixels, in the original image. A line representing a best straight line fit is also shown. FIG. 1(b) shows the image component after a 45-degree counterclockwise rotation, along with the line representing the best line fit. According to the inventor's calculation, the R² value calculated with the original image data (FIG. 1(a)) is 0.23 and the trend line is about 68 degrees, while the R² value calculated after the image component is rotated 45 degrees (FIG. 1(b)) is 0.93 and the trend line is about 132 degrees. The value 0.93 indicates that the image component is close to a straight line. Thus, this example illustrates that the determination of linearity can be improved by rotating the image component away from the near vertical orientation.

FIG. 2 schematically illustrates a method for removing straight lines from document image according to an embodiment of the present invention. First, a hard copy document is scanned to generate a digital image of the document (step S201). The document image is pre-processed as appropriate, such as binarization, removal of isolated noise peaks, etc. (step S202). Steps S201 and S202 and optional. For example, the digital document image may be obtained from another source such as another data processing apparatus, etc. and the pre-processing step may have already been completed by the other data processing system. The document image being processed in the subsequent steps is a binary image.

The binary document image is analyzed to obtain a plurality of image components (step S203). Each image component comprises a set of black pixels, each pixel having x and y coordinates. The image components may be obtained by a connected component analysis, i.e., finding groups of black pixels that are connected to each other. Any suitable techniques may be used to accomplish this step. In some implementations, optional preliminary steps may be applied to rule out some image components from subsequent analysis. For example, the size of the bounding box (a rectangular box that bounds the image component) may be calculated, and if the bounding box height and width are smaller than certain predetermined size values (e.g. typical or estimated height and width values of text characters in the document), the image components are not further processed. This is because such image components are unlikely to be candidates for background removal. If such preliminary steps are carried out, they can be considered a part of step S203.

For each image component (step S204), a first straight line fit is calculated using Eq. (1), and a first coefficient of determination is calculated using Eq. (2) using the original coordinates of the black pixels (step S205). The image component is also rotated, preferably by 45 degrees (step S206). This may be done by applying a rotation matrix to the pixel coordinates of the image component. Although a 45-degree rotation is preferred, other rotation angles such as 40 degrees, 50 degrees, etc. may also be used. The rotation may be either clockwise or counterclockwise. As a result of the rotation, new x and y coordinates (x′ᵢ, y′ᵢ) for each black pixel are generated. After rotation, a second straight line fit is calculated for the rotated image component using Eq. (1) and a second coefficient of determination is calculated using Eq. (2) (step S207) using the new coordinates (x′ᵢ, y′ᵢ) (i.e., xᵢ and yᵢ are replaced by x′ᵢ and y′ᵢ). Then, the higher one of the first and second coefficients of determination calculated above is compared to a threshold value to determine whether the image component is a straight line (step S208).

It is noted that all image components are subject to the rotation and second straight line fitting (steps S206 and S207). Thus, it is not necessary to determine whether the first fitted straight line (step S205) is near-vertical or near-horizontal or whether a rotation is necessary.

If the higher one of the two coefficients of determination is not greater than the threshold value (“N” in step S209), the image element is determined not to be a straight line and the analysis moves on to the next image element. If the higher one of the two coefficients of determination is greater than the threshold value (“Y” in step S209), the image component is determined to be a straight line. Then, a length of the image component (the line) is estimated (step S210). The length may be estimated using, for example, the maximum and minimum x values and maximum and minimum y values. If the length is not greater than a threshold length (“N” in step S211), the image element is determined not to be a straight line to be removed as background. The reason is that short straight lines can be a part of text characters and should not be removed as background. The threshold length should be set appropriately using the above consideration.

If the image component is determined to be a straight line (“Y” in step S209) and its length is greater than the threshold length (“Y” in step S211), the image component is removed as background (step S212). The removal step may be implemented in a number of ways. For example, the pixel values of these pixels of the digital image may be changed from the black value to the white value. Alternatively, the image component may be flagged as being background without actually changing the pixel values of the digital image. The flags may be examined in subsequent image processing steps to determine appropriate actions. For example, an OCR step may ignore any image components that are flagged as being non-text.

Steps S205 to S212 are repeated for all image components. The processed digital image may be printed or stored for further processing.

In the method shown in FIG. 2, the method for detecting a straight line, i.e. steps S205 to S209, is used for purpose of background line removal (e.g. step S212). It should be noted that the straight line detection method (S205 to S209) can also be used in other processes related to background removal for document images. For example, when a background line intersects with or touches a text character, the image component may have the shape of a straight line (or substantially straight line) segment joined with a curved line segment, either with or without branches. The straight line detection method (S205 to S209) may be used as a part of a method to determine where the straight line (background) ends and the curved line (text character) starts.

It will be apparent to those skilled in the art that various modification and variations can be made in the document image processing method of the present invention without departing from the spirit or scope of the invention. Thus, it is intended that the present invention cover modifications and variations that come within the scope of the appended claims and their equivalents.

What is claimed is:

1. A method of processing a binary document image, comprising:
(a) obtaining a plurality of image components from the document image, each image components comprising a set of black pixels, each black pixel having x and y coordinates;
for each image component,
(b) calculating a first straight line fit and a first coefficient of determination using the x and y coordinates of the set of black pixels;
(c) rotating the image component by a predetermined angle to generate rotated x and y coordinates for each of the set of black pixels;
(d) calculating a second straight line fit and a second coefficient of determination using the rotated x and y coordinates of the set of black pixels;
(e) if a higher one of the first and second coefficients of determination calculated in steps (b) and (d) is higher than a first threshold value, estimating a length of the image component; and
(f) if the length estimated in step (e) is longer than a second threshold value, removing the image component from the document image.

2. The method of claim 1,
wherein in step (b), the first straight line fit is calculated using a linear model:
$$y = f ( x ) = a + bx$$
$$a = \frac{\overline{y} {\sum }_{i}^{ } {x}_{i}^{2} - \overline{x} {\sum }_{i}^{ } {x}_{i} {y}_{i}}{{\sum }_{i}^{ } {x}_{i}^{2} - n {\overline{x}}^{2}}$$
$$b = \frac{{\sum }_{i}^{ } {x}_{i} {y}_{i} - n \overline{x} \overline{y}}{{\sum }_{i}^{ } {x}_{i}^{2} - n {\overline{x}}^{2}}$$
where (xᵢ, yᵢ) are the x and y coordinates of the set of black pixels, x̅ and y̅ are average values of xᵢ and yᵢ and n is a total number of black pixels in the image component,
wherein the first coefficient of determination is calculated using
$$1 - \frac{{\sum }_{i}^{ } {( {y}_{i} - f ( {x}_{i} ) )}^{2}}{{\sum }_{i}^{ } {( {y}_{i} - \overline{y} )}^{2}} ;$$
wherein in step (d), the second straight line fit is calculated using a linear model:
$$y = {f}^{′} ( x ) = {a}^{′} + {b}^{′} x$$
$${a}^{′} = \frac{\overline{{y}^{′}} {\sum }_{i}^{ } {x}_{i}^{′2} - \overline{{x}^{′}} {\sum }_{i}^{ } {x}_{i}^{′} {y}_{i}^{′}}{{\sum }_{i}^{ } {x}_{i}^{′2} - n {\overline{{x}^{′}}}^{2}}$$
$${b}^{′} = \frac{{\sum }_{i}^{ } {x}_{i}^{′} {y}_{i}^{′} - n \overline{{x}^{′}} \overline{{y}^{′}}}{{\sum }_{i}^{ } {x}_{i}^{′2} - n {\overline{{x}^{′}}}^{2}}$$
where (x′ᵢ, y′ᵢ) are the rotated x and y coordinates of the set of black pixels, x̅′ and y̅′ are average values of x′ᵢ and y′ᵢ, and n is a total number of black pixels in the image component, and
wherein the second coefficient of determination is calculated using
$$1 - \frac{{\sum }_{i}^{ } {( {y}_{i}^{′} - {f}^{′} ( {x}_{i}^{′} ) )}^{2}}{{\sum }_{i}^{ } {( {y}_{i}^{′} - \overline{{y}^{′}} )}^{2}} .$$

3. The method of claim 1, wherein the predetermined angle in step (c) is 45 degrees.

4. A computer program product comprising a computer usable non-transitory medium having a computer readable program code embedded therein for controlling a data processing apparatus, the computer readable program code configured to cause the data processing apparatus to execute a process for processing a binary document image, the process comprising:
(a) obtaining a plurality of image components from the document image, each image components comprising a set of black pixels, each black pixel having x and y coordinates;
for each image component,
(b) calculating a first straight line fit and a first coefficient of determination using the x and y coordinates of the set of black pixels;
(c) rotating the image component by a predetermined angle to generate rotated x and y coordinates for each of the set of black pixels;
(d) calculating a second straight line fit and a second coefficient of determination using the rotated x and y coordinates of the set of black pixels;
(e) if a higher one of the first and second coefficients of determination calculated in steps (b) and (d) is higher than a first threshold value, estimating a length of the image component; and
(f) if the length estimated in step (e) is longer than a second threshold value, removing the image component from the document image.

5. The computer program product of claim 4,
wherein in step (b), the first straight line fit is calculated using a linear model:
$$y = f ( x ) = a + bx$$
$$a = \frac{\overline{y} {\sum }_{i}^{ } {x}_{i}^{2} - \overline{x} {\sum }_{i}^{ } {x}_{i} {y}_{i}}{{\sum }_{i}^{ } {x}_{i}^{2} - n {\overline{x}}^{2}}$$
$$b = \frac{{\sum }_{i}^{ } {x}_{i} {y}_{i} - n \overline{x} \overline{y}}{{\sum }_{i}^{ } {x}_{i}^{2} - n {\overline{x}}^{2}}$$
where (xᵢ, yᵢ) are the x and y coordinates of the set of black pixels, x̅ and y̅ are average values of xᵢ and yᵢ and n is a total number of black pixels in the image component,
wherein the first coefficient of determination is calculated using
$$1 - \frac{{\sum }_{i}^{ } {( {y}_{i} - f ( {x}_{i} ) )}^{2}}{{\sum }_{i}^{ } {( {y}_{i} - \overline{y} )}^{2}} ;$$
wherein in step (d), the second straight line fit is calculated using a linear model:
$$y = {f}^{′} ( x ) = {a}^{′} + {b}^{′} x$$
$${a}^{′} = \frac{\overline{{y}^{′}} {\sum }_{i}^{ } {x}_{i}^{′2} - \overline{{x}^{′}} {\sum }_{i}^{ } {x}_{i}^{′} {y}_{i}^{′}}{{\sum }_{i}^{ } {x}_{i}^{′2} - n {\overline{{x}^{′}}}^{2}}$$
$${b}^{′} = \frac{{\sum }_{i}^{ } {x}_{i}^{′} {y}_{i}^{′} - n \overline{{x}^{′}} \overline{{y}^{′}}}{{\sum }_{i}^{ } {x}_{i}^{′2} - n {\overline{{x}^{′}}}^{2}}$$
where (x′ᵢ, y′ᵢ) are the rotated x and y coordinates of the set of black pixels, x̅′ and y̅′ are average values of x′ᵢ and y′ᵢ and n is a total number of black pixels in the image component, and
wherein the second coefficient of determination is calculated using
$$1 - \frac{{\sum }_{i}^{ } {( {y}_{i}^{′} - {f}^{′} ( {x}_{i}^{′} ) )}^{2}}{{\sum }_{i}^{ } {( {y}_{i}^{′} - \overline{{y}^{′}} )}^{2}} .$$

6. The computer program product of claim 4, wherein the predetermined angle in step (c) is 45 degrees.
